(19) United States
(12) Patent Application Publication
(10) Pub. No.: US 2017/0193399 A1
(43) Pub. Date: Jul. 6, 2017

(54) METHOD AND DEVICE FOR CONDUCTING CLASSIFICATION MODEL TRAINING

(71) Applicant: Xiaomi Inc., Beijing (CN)

(72) Inventors: Pingze WANG, Beijing (CN); Tao ZHANG, Beijing (CN); Fei LONG, Beijing (CN)

(73) Assignee: Xiaomi Inc.

(21) Appl. No.: 15/391,923

(22) Filed: Dec. 28, 2016

(30) Foreign Application Priority Data
Dec. 30, 2015 (CN) 201511020827.X

(51) Int. Cl. G06N 99/00; G06N 5/04

(52) U.S. Cl. CPC G06N 99/005; G06N 5/04

(57) ABSTRACT

A method for conducting classification model training includes: acquiring sample feature vectors of a plurality of users according to at least one feature set for each of the users, wherein the at least one feature set for a user is determined based on at least one sample message of the user; determining gender identifiers of the users according to the sample feature vectors; and conducting training based on the sample feature vectors and the gender identifiers corresponding to the sample feature vectors to construct a gender classification model.

### CROSS-REFERENCE TO RELATED APPLICATIONS

This application is based on and claims priority to Chinese Patent Application No. 201511020827.X, filed on Dec. 30, 2015, which is incorporated herein by reference in its entirety.

### TECHNICAL FIELD

The present disclosure generally relates to the field of information technology, and more particularly, to a method and device for conducting classification model training.

### BACKGROUND

Generally, when a user performs a login, shopping, payment and other operations at a website, the website may send a notification message to the user according to a telephone number registered by the user in advance, in order to prompt the user to perform another operation.

The notification message generally includes the user's personal information, so that the user's personal information can be acquired through analysis of such a notification message. For example, when a user bought goods on a website, the seller may send a notification message about the delivery to the user. An exemplary notification message may read: “<# Name #>Hello, your ordered <# Order No. #>goods has been processed to be delivered. The distribution company is <# Courier Company #>, and the tracking number is <# Tracking No. #>.” From the notification message, the user's name, order number or the like can be acquired.

However, the notification message seldom contains information about the gender of a user, so it is difficult to determine the gender of the user.

### SUMMARY

According to one aspect of the present disclosure, there is provided a method for conducting classification model training. The method includes: acquiring sample feature vectors of a plurality of users according to at least one feature set for each of the users, wherein the at least one feature set for a user is determined based on at least one sample message of the user; determining gender identifiers of the users according to the sample feature vectors; and conducting training based on the sample feature vectors and the gender identifiers corresponding to the sample feature vectors to construct a gender classification model.

According to another aspect of the present disclosure, there is provided a device including a processor and a memory configured to store instructions executable by the processor. The processor is configured to: acquire sample feature vectors of a plurality of users according to at least one feature set for each of the users, wherein the at least one feature set for a user is determined based on at least one sample message of the user; determine gender identifiers of the users according to the sample feature vectors; and conduct training based on the sample feature vectors and the gender identifiers corresponding to the sample feature vectors to construct a gender classification model.

According to another aspect of the present disclosure, there is provided a non-transitory readable storage medium storing instructions that, when executed by a processor of a device, cause the device to perform a method for conducting classification model training, the method including: acquiring sample feature vectors of a plurality of users according to at least one feature set for each of the users, wherein the at least one feature set for a user is determined based on at least one sample message of the user; determining gender identifiers of the users according to the sample feature vectors; and conducting training based on the sample feature vectors and the gender identifiers corresponding to the sample feature vectors to construct a gender classification model.

It is to be understood that both the forgoing general description and the following detailed description are exemplary only, and are not restrictive of the present disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart of a method for conducting classification model training according to an exemplary embodiment.

FIG. 2 is a flow chart of a method for conducting classification model training according to another exemplary embodiment.

FIG. 3 is a schematic diagram illustrating a classification model according to an exemplary embodiment.

FIG. 4 is a block diagram of a device for conducting classification model training according to an exemplary embodiment.

FIG. 5 is a block diagram of a device for conducting classification model training according to yet another exemplary embodiment.

FIG. 6 is a block diagram of a device for conducting classification model training according to yet another exemplary embodiment.

### DETAILED DESCRIPTION

The exemplary embodiments, as shown in the accompany drawings, will be described in detail. When referring to the drawings in the following descriptions, the same reference number throughout the figures represents the same or similar element, unless otherwise indicated. The implementations described in the following exemplary embodiments are not representative of all the implementations that are consistent with this disclosure. Instead, they are only examples of devices and methods that are consistent with some aspects of the disclosure, as described in the accompanying claims.

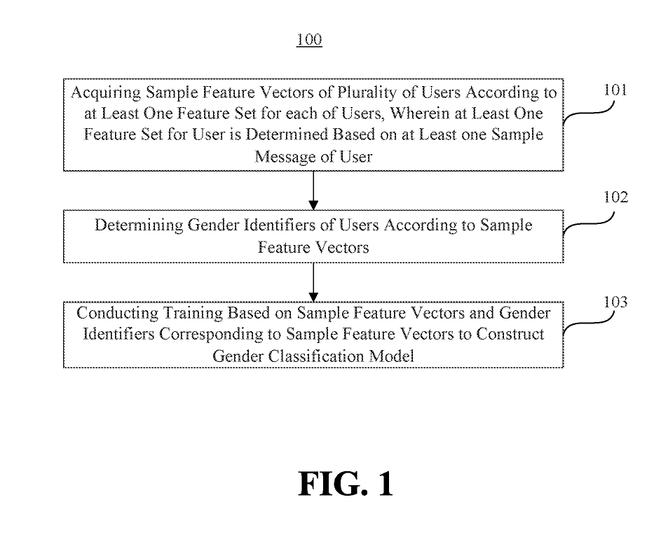

FIG. 1 is a flow chart of a method 100 for conducting classification model training according to an exemplary embodiment. The method 100 can be performed by an electronic classification device. As shown in FIG. 1, the method 100 may include the following steps.

In step 101, sample feature vectors of a plurality of users are acquired according to at least one feature set for each of the users. The at least one feature set for a user is determined based on at least one sample message of the user.

In step 102, gender identifiers of the users are determined according to the sample feature vectors.

In step 103, training is conducted based on the sample feature vectors and the gender identifiers corresponding to the sample feature vectors to construct a gender classification model.

In the illustrated embodiment, the method 100 for conducting classification model training includes obtaining a gender classification model by acquiring sample feature vectors of a plurality of users according to at least one feature set for each of the users, determining gender identifiers of the users according to the sample feature vectors, and conducting training based on the sample feature vectors and the gender identifiers corresponding to the sample characteristic vectors. The gender classification model can be applied to gender classification so as to determine gender of a user according to the user's sample message such that more information can be acquired from the sample message, thereby to improve flexibility.

In an embodiment, conducting the training based on the sample feature vectors and the gender identifiers corresponding to the sample feature vectors to obtain the gender classification model may include: conducting the training based on the sample feature vectors and the gender identifiers corresponding to the sample feature vectors by using a decision tree algorithm to obtain the gender classification model.

In an embodiment, conducting the training based on the sample feature vectors and the gender identifiers corresponding to the sample feature vectors by using a decision tree algorithm to obtain the gender classification model may include:

(a) combining the sample feature vectors and the gender identifiers corresponding to the sample feature vectors to form a current set of feature data;

(b) acquiring, at a current level, gain values of feature dimensions of the current set of feature data, wherein a feature dimension corresponds to a feature value at a corresponding position within the sample feature vectors, and a gain value corresponding to the feature dimension represents an extent to which the feature dimension affects results of gender classification;

(c) determining a feature dimension within the current set of feature data that has the largest gain value as a test dimension, and constructing, at the current level, a node corresponding to the test dimension;

(d) dividing the current set of feature data into at least one subset of the feature data in accordance with a feature value corresponding to the test dimension in the current set of feature data, and deleting feature values corresponding to the test dimension from the at least one subset, to obtain at least one set of feature data;

(e) forwarding the at least one set of feature data to a level lower than the current level and constructing a branch node of the node at the current level according to the at least one set of feature data;

(f) repeating steps (b)-(e) until a current set of feature data contains one kind of gender identifier;

(g) constructing a node according to the gender identifier; and

(h) assembling the nodes constructed at the levels to form the gender classification model.

In an embodiment, the method 100 may further include: classifying a target user based on the gender classification model to obtain a gender identifier of the target user.

In an embodiment, classifying the target user based on the gender classification model to obtain the gender identifier of the target user may include: acquiring a target feature vector of the target user according to at least one feature set for the target user, wherein the at least one feature set for the target user is determined based on at least one target message of the target user; and determining the gender identifier of the target user according to the target feature vector and the gender classification model.

In an embodiment, the method 100 may further include: acquiring the at least one target message of the target user every a preset period of time, and determining the at least one feature set for the target user from the at least one target message; or acquiring the at least one target message of the target user upon detection that target messages of the target user have increased by a preset threshold number, and determining the at least one feature set for the target user from the at least one target message.

In an embodiment, the at least one feature set for the target user may include at least one of: a salutation feature set, an operation feature set, or an application feature set.

In an embodiment, the salutation feature set may include a male salutation feature set and/or a female salutation feature set.

In an embodiment, the operation feature set may include at least one of the following parameters: a number of times of online shopping, a number of times of participating in group-shopping, and an amount of consumption per month, e.g., in a monthly bill.

In an embodiment, the application feature set may include one of the following parameters: a number of APP (application) registration and/or gender-specific APP.

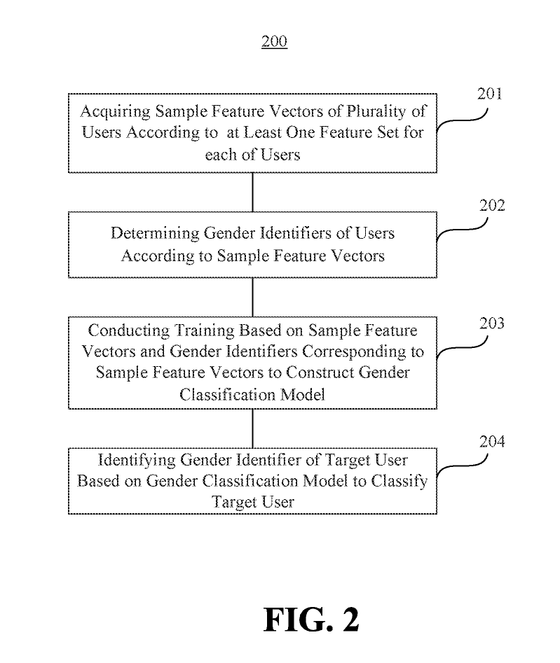

FIG. 2 is a flow chart of a method 200 for conducting classification model training according to an exemplary embodiment. The method 200 for classification model training can be performed by in an electronic classification device, and may include the following steps, as shown in FIG. 2.

In step 201, sample feature vectors of a plurality of users are acquired according to at least one feature set for each of the users.

The classification device may be a terminal or a server. The present embodiment is not limited to these examples.

In the present embodiment, in order to more accurately classify a user and determine gender of the user, a gender classification model can be obtained by training in advance.

For each user, the classification device may consider a historical message of the user as a sample message. Based on at least one sample message, at least one feature set of the user is obtained. According to the at least one feature set for each of the plurality of the users, sample feature vectors of the users are acquired. The sample feature vectors of the plurality of users are trained to construct a gender classification model.

The historical message may include, among others, a message that has been received or transmitted by a terminal or server of the user. Since a notification message may contain more gender features than other kinds of messages, the classification device may acquire at least one notification message from historical messages of the user and acquires the at least one feature set according to the at least one notification message as a set of features for the user, in order to reduce calculation. The present embodiment is not limited thereto.

The sample feature vector of a user may include feature values for multiple feature dimensions. The feature dimensions of the sample feature vector may include the following parameters: a total number of male salutation, a number of times of online shopping, a number of App registration, or the like. The present disclosure is not limited to these examples. In each feature vector, one feature dimension corresponds to one feature value, and the feature values corresponding to the feature dimensions may vary, depending on detailed information of the at least one sample message of the user.

For example, the sample feature vector may include three feature dimensions: a total number of male salutation, a number of times of online shopping, a number of App registration. Assuming a user has ten sample messages, among which there are three sample messages containing the salutation “Sir”, five sample messages that are delivery messages, and four sample messages that are verification messages for APP registration, the sample feature vector of the user has a feature value of 3 under the parameter of “total number of male salutation”, and a feature value of 5 under the parameter of “number of online shopping”, and a feature value of 4 under the parameter of “number of APP registration”. That is, the sample feature vector of the user is {3, 5, 4}.

The sample feature vector may have multiple feature dimensions. To manage the feature dimensions of the sample feature vector, for example, the multiple feature dimensions can be divided into three feature sets: a salutation feature set, an operation feature set, and an application feature set, according to salutations, operations, and applications indicated in the sample messages. The feature sets for the user may include at least one of the salutation feature set, the operation feature set, or the application feature set.

Sample feature sets are explained as follows.

1. The salutation feature set includes a feature set of salutation in at least one sample message. The salutation feature set may include a male salutation feature set and/or a female salutation feature set. The salutation in at least one sample message may be “Sir”, “Mr.” “Handsome boy”, “Madam”, “Miss”, “Beautiful girl”, etc., which include male salutation and female salutation. The feature dimension corresponding to the male salutation feature set may include a total number of male salutation, and the feature dimension corresponding to the female salutation feature set may include a total number of female salutation. In some embodiments, the feature dimension corresponding to the salutation feature set may include an indication of whether a total number of male salutation is larger than a total number of female salutation, etc.

2. The operation feature set includes a feature set of operation indicated in at least one sample message. The operation feature set may include one of the following parameters: a number of times of online shopping, a number of times of participation in group-shopping, and an amount of consumption per month, week, or year. Of course, the operation feature set may include parameters of other operation features.

For example, the parameter of a number of times of online shopping of a user can be obtained from a number of delivery messages for the user. The parameter of a number of times of participation in group-shopping can be obtained from a number of the group-shopping messages for the user. The amount of consumption per month can be obtained from a credit card bill message for the user. The parameter of the amount of consumption per month may include a number of transactions, an average amount of consumption, etc.

3. The application feature set includes a feature set of APP indicated in the at least of sample message. The application feature set may include one of the following parameters: a number of APP registration or gender-specific APP. The application feature set may also include other APP-related parameters.

For example, a number of APP registration may be obtained according to a verification code message generated when an APP was being registered, and a gender-specific APP may be identified according to a type of a registered APP. The gender-specific APP may include a female-specific APP or a male-specific APP. For example, a female may generally use a female-specific APP such as a menstruation management APP, a shop-cosmetics APP, a shop-clothes APP, a beauty APP. The parameters of a female-specific APP may include: whether or not to use a menstruation management APP, a number of shop-cosmetics APP registration, and/or a number of shop-clothes APP registration. For example, a male may generally use a male-specific APP, such as a financial management APP, a game APP, a sports APP, and/or a news APP. The parameters of a male-specific APP may include: a number of financial management APP registration, a number of game APP registration, whether or not to use a sports APP, and/or whether or not to use a news APP.

After the classification device acquires feature values of at least one sample message under each of a plurality of feature dimensions, the feature values under the plurality of feature dimensions can be gathered to form the feature sets, from which the sample feature vector of the user may be obtained.

For example, a user has twenty sample messages, among which there are four sample messages containing the salutation “Sir”, one sample message containing “Handsome boy”, five sample messages that are delivery messages, three sample messages that are group-shopping messages, and twelve sample messages that are verification code messages for APP registration. Among the twelve verification code messages, there are five verification code messages for game APP registration. According to the five feature dimensions, i.e. the parameters of the total number of male salutation, the number of online shopping, the number of group shopping, the number of APP registration, and the number of game APP registration, the feature values under the five parameters can be determined as 5, 5, 3, 12, 5, such that the sample feature vector of the user can be expressed as, for example, {5, 5, 3, 12, 5}.

Referring again to FIG. 2, in step 202, gender identities of the users are determined according to the sample feature vectors.

The classification device can determine a gender identifier for the users. The gender identifier may be male or female. The gender identifier of a user may be acquired from a result of classifying the sample feature vector of the user. Training can be conducted to obtain a gender classification model according to the sample feature vectors and the gender identities of the users.

In step 203, training is conducted based on the sample feature vectors and the gender identifiers corresponding to the sample feature vectors to construct a gender classification model.

After obtaining the sample feature vectors of the users, the classification device can conduct training on the sample feature vectors and the gender identities corresponding to the respective sample feature vectors by using a decision tree algorithm to obtain a gender classification model. In some embodiments, the classification device may utilize other algorithms such as SVM (Support Vector Machine) or the like to conduct training to obtain the gender classification model. The preset algorithm for training in the present disclosure is not limited to these examples.

In some embodiments, conducting training on the sample feature vectors and the gender identities corresponding to the respective sample feature vectors by using the decision tree algorithm to obtain a gender classification model may include the following steps.

Step 1. The classification device combines the sample feature vectors and the gender identities corresponding to the respective sample feature vectors to form a current set of feature data.

Step 2. At each level of the training, the classification device acquires gain values for feature dimensions of a current set of feature data, determines a feature dimension within the current set of feature data that has the largest gain value as a test dimension, and constructs, at a current level, a node corresponding to the test dimension The node may be an initial node of a decision tree or a branch node of an upper level node.

For example, a current set of feature data formed by combining the sample feature vectors of the plurality of users and the gender identities of the users corresponding to the sample feature vectors belong is shown in Table 1 below. In Table 1, the male identifier is denoted as “1 ”, and the female identifier is denoted as “0”.

TABLE 1

| | The total | The total | | | |
|---|---|---|---|---|---|
| | number of | number of | The number | The | The number of |
| | male | female | of online | number of | participation in |
| User | salutation | salutation | shopping | delivery | group-shopping |
| A | 12 | 0 | 7 | 10 | 3 |
| B | 1 | 15 | 13 | 15 | 9 |
| C | 13 | 7 | 5 | 6 | 11 |
| D | 20 | 2 | 7 | 9 | 7 |
| E | 2 | 18 | 15 | 20 | 13 |

| | | | The number of | |
|---|---|---|---|---|
| | Average amount | The number of | game APP | Gender |
| User | of consumption | APP registration | registration | identifier |
| A | 200 | 35 | 9 | 1 |
| B | 178 | 45 | 1 | 0 |
| C | 107 | 39 | 7 | 1 |
| D | 153 | 29 | 5 | 1 |
| E | 137 | 33 | 0 | 0 |

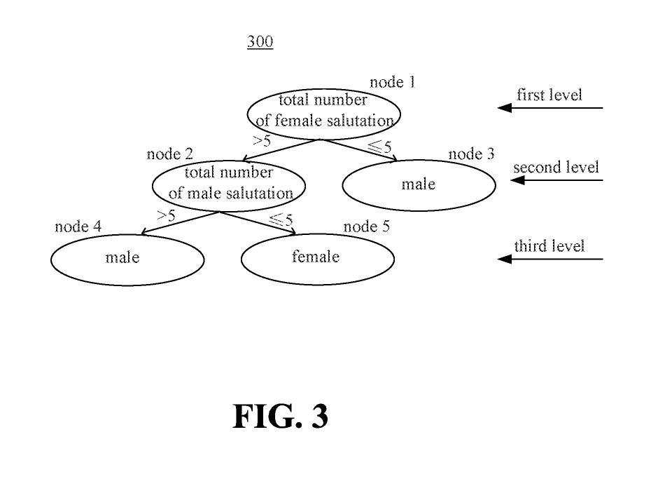

A gain value of each feature dimension in the set of feature data in Table 1 is calculated and a largest gain value is identified. For example, the feature dimension of “The total number of female salutation” is determined to have the largest gain value and is determined as a test dimension. According to the current set of feature data and the test dimension, a node 1 is constructed, as shown in FIG. 3.

Step 3. According to at least one feature value corresponding to the test dimension in the set of feature data, the current set of feature data is divided into at least one subset. The feature values corresponding to the test dimension in the at least one subset are deleted such that at least one set of feature data is obtained.

A feature dimension corresponds to a feature value at a corresponding position of the plurality of sample feature vectors. The gain value for a feature dimension represents an extent to which the feature dimension affects results of gender classification. The gain value of a feature dimension may be calculated by using an algorithm such as Information Gain algorithm, a Chi-square test, etc. The present disclosure is not limited to these examples.

In some embodiments, the division of the current set of feature data into at least one subset according to at least one feature value corresponding to the test dimension in the set of feature data may include the steps of the following Method 1 or Method 2.

In Method 1, the set of feature data is divided into a plurality of subsets based on that the at least one feature value corresponding to the test dimension is different from feature values corresponding to other subsets such that the feature values within the same subset corresponding to the test dimension are equal and that feature values within different subsets are different.

In Method 2, the set of feature data is divided into a plurality of subsets based on that the at least one feature value corresponding to the test dimension is within a predetermined range such that feature values within the same subset corresponding to the test dimension are all within the predetermined range and that feature values within different subsets are within different ranges.

Referring to FIG. 3, each sample feature vector has two ranges of feature values under the test dimension of “the total number of female salutation”, i.e. feature values being greater than five (>5) and feature values being not greater than five (≦5). That is, the current set of features values are divided into two groups according to the above method 2. A sample feature vector having feature values that “the total number of female salutation” is more than 5 within the current set of feature data is grouped as a first subset of feature data, and a sample feature vector having feature values that “the total number of female salutation” is not more than 5 within the current set of feature data is grouped as a second subset of feature data. By deleting the feature values under the dimension of “the total number of female salutation” from the two subsets of feature data in Table 1, two sets of feature data are obtained, as shown in Table 2 and Table 3 below, where Table 2 shows the first subset of feature data and Table 3 shows the second subset of feature data after their feature values under “the total number of female salutation” are deleted.

TABLE 2

| | The total | The number | | |
|---|---|---|---|---|
| | number of | of online | The number of | The number of |
| User | male salutation | shopping | delivery | group-shopping |
| B | 1 | 13 | 15 | 9 |
| C | 13 | 5 | 6 | 11 |
| E | 2 | 15 | 20 | 13 |

| | Average | The number | The number of | |
|---|---|---|---|---|
| | amount of | of APP | game-play APP | |
| User | consumption | registration | registration | Gender identifier |
| B | 178 | 45 | 1 | 0 |
| C | 107 | 39 | 7 | 1 |
| E | 137 | 33 | 0 | 0 |

TABLE 3

| | The total | The number | | |
|---|---|---|---|---|
| | number of | of online | The number of | The number of |
| User | male salutation | shopping | delivery | group-shopping |
| A | 12 | 7 | 10 | 3 |
| D | 20 | 7 | 9 | 7 |

| | Average | The number | The number of | |
|---|---|---|---|---|
| | amount of | of APP | game-play APP | |
| User | consumption | registration | registration | Gender identifier |
| A | 200 | 35 | 9 | 1 |
| D | 153 | 29 | 5 | 1 |

Step 4. The at least one set of feature data after the division according to the at least one feature value corresponding to the test dimension is forwarded to a next/second level that is lower than the current level. At the second level, the steps 2 and 3 described above are repeated to construct a second node, which is a branch node constructed at the second level under a corresponding feature value conditions. The steps 2, 3, and 4 are repeated until a current set of feature data contains only one kind of gender identifier. A node is constructed according to the gender identifier. The nodes constructed at multiple levels are grouped to form a gender classification model.

If a current level is a first level, the classification device can construct one node according to the determined test dimension at the first level, and construct branch nodes at a second level according to the feature values corresponding to another test dimension. The classification device can perform the steps 2 to step 4 repeatedly on the set of feature data to construct each node in the second level, and so on for additional levels, until a current set of feature data contains only one kind of gender identifier.

When constructing a node, the classification device determines whether or not the current set of feature data contains only one kind of gender identifier. If the current set of feature data contains only one kind of gender identifier, a node is constructed according to the gender identifier without calculation for a test dimension. If the current set of feature data contains multiple gender identifiers, a test dimension is calculated according to the current set of feature data. A node is constructed as a branch node of an upper level.

Referring to FIG. 3, the two divided sets of feature data as shown in Tables 2 and 3 are forwarded to the second level. At the second level, since the set of feature data shown in Table 2 contains two kinds of gender identifiers, 1 and 0, a feature dimension that has the largest gain value is calculated, which is “the total number of male salutation.” The feature dimension is determined as a test dimension to construct a node 2. Further, since the set of feature data shown in Table 3 contains only one kind of gender identifier, i.e. “1,” there is no need to calculate a test dimension. A node 3 “male” can be constructed accordingly. The nodes 2 and 3 are branch nodes of the node 1, wherein the node 2 is a branch node of the node 1 under the condition that the total number of female salutation is more than 5, and the node 3 is a branch node of the node 1 under the condition that the total number of female salutation is not more than 5.

With respect to the node 2, the test dimension of “the total number of male salutation” within the set of feature data shown in Table 2 contains two kinds of feature values: feature values being greater than five (>5) and feature values being not greater than five (≦5). A sample feature vector having feature values that “the total number of male salutation” is more than 5 within the set of feature data is grouped as a third subset of feature data, and a sample feature vector having feature values that “the total number of male salutation” is not more than 5 within the set of feature data is grouped as a fourth subset of feature data. By deleting the feature values under the dimension of “the total number of male salutation” from the third and fourth subsets of feature data, the following two sets of feature data are obtained, as shown in Table 4 and Table 5, where Table 4 shows the third subset of feature data and Table 5 shows the fourth subset of feature data after the dimension of “the total number of male salutation” is deleted.

TABLE 4

| | The | The | The | | The | The | |
|---|---|---|---|---|---|---|---|
| | number | number | number of | Average | number of | number of | Gender |
| | of online | of | group- | amount of | APP | game | identifier |
| User | shopping | delivery | shopping | consumption | registration | registration | APP |
| C | 5 | 6 | 11 | 107 | 39 | 7 | 1 |

TABLE 5

| | The | The | The | | The | The | |
|---|---|---|---|---|---|---|---|
| | number | number | number of | Average | number of | number of | |
| | of online | of | group- | amount of | APP | game APP | Gender |
| User | shopping | delivery | shopping | consumption | registration | registration | identifier |
| B | 13 | 15 | 9 | 178 | 45 | 1 | 0 |
| E | 15 | 20 | 13 | 137 | 33 | 0 | 0 |

The sets of feature data shown in Table 4 and Table 5 are forwarded to a third level. At the third level, since the sets of feature data shown in both Table 4 and Table 5 contain only one kind of gender identifier, there is no need to calculate a test dimension. A node 4 “male” and node 5 “female” can be constructed at the third level as shown in FIG. 3. The nodes 4 and 5 are used as branch nodes of the node 2, wherein the node 4 is a branch node of the node 2 under the condition that “the total number of male salutation” is more than 5, and the node 5 is a branch node of the node 2 under the condition that “the total number of male salutation” is not more than 5. The nodes 1-5 are assembled to form a gender classification model 300.

Referring back to FIG. 2, in step 204, a gender identifier of a target user is identified based on the gender classification model to classify the target user.

When classifying the target user after the gender classification model is obtained, the classification device may acquire at least one target message of the target user, including a message that has been sent or received by the target user using a terminal or server. The classification device may determine at least one feature set according to the at least one target message of the target user, acquire a target feature vector according to the at least one feature set of the target user, and enter the target feature vector into the gender classification model established by training to determine the gender identifier of the target user based on the target feature vector and the gender classification model, so as to acquire the gender of the target user.

Since a notification message may contain more features with respect to the target user, the classification device may acquire a notification message from a plurality of messages of the target user as a target message. For example, regarding each message of the target user, the classification device determines whether the phone number from which the message was sent is a preset number or not. If it is a preset number, the message can be determined as a notification message.

The preset number may be a phone number of a seller, a delivery service company, a bank, or a preset organization. The present disclosure is not limited to these examples.

To use the gender classification model to find the gender identifier of the target user, the classification device acquires the target feature vector from a target message of the target user. A number of dimensions of the target feature vector is the same as the number of the dimensions of the sample feature vector of the gender classification model. Further, dimensions of the target feature vector correspond to the dimensions of the sample feature vector, in order to obtain the gender identifier of the user according to the gender classification model.

The procedure of acquiring the target feature vector in step 204 is the same as that of acquiring the sample feature vector in step 201, and will not be repeated herein.

In some embodiments, in order to improve accuracy of classification, more than one target message of the target user can be acquired, and classification is repeatedly conducted according the acquired target messages such that the gender identifier of the target user can be updated.

The target messages can be acquired by one of the following methods.

1. The classification device can acquire the at least one target message of the target user in each preset period of time, and determine the at least one feature set for the target user from the at least one target message, to obtain a latest target feature vector so as to determine the gender identifier of the target user.

2. The classification device can acquire the at least one target message of the target user upon detection that target messages of the target user have increased by a preset threshold number, and determine the at least one feature set for the target user from the at least one target message, to obtain a latest target feature vector so as to determine the gender identifier of the target user.

Of course, the at least one target message can be acquired at other timing to determine a latest target feature vector so as to determine the gender identifier of the target user. The present disclosure is not limited these methods.

When acquiring the at least one target message of the target user, the classification device can acquire all of the target messages of the target user until the time of acquisition, or new target messages since the time the prior target messages were acquired. The present disclosure is not limited thereto.

When the gender identifier of the target user is determined, the gender of the target user can be determined. Because a user with a different gender may have a different hobby, information to be recommended to the user can be grouped into female-favorite information and male-favorite information, so that the information can be recommended to the user according to the gender of the target user.

For example, sports news and information regarding outdoor products can be recommended to a male, while information of shopping discount and cosmetics can be recommended to a female.

The following descriptions are related to a device of the present disclosure that can be used to perform the methods as described in the above embodiments. Details of the following devices may be referred to the above method embodiments.

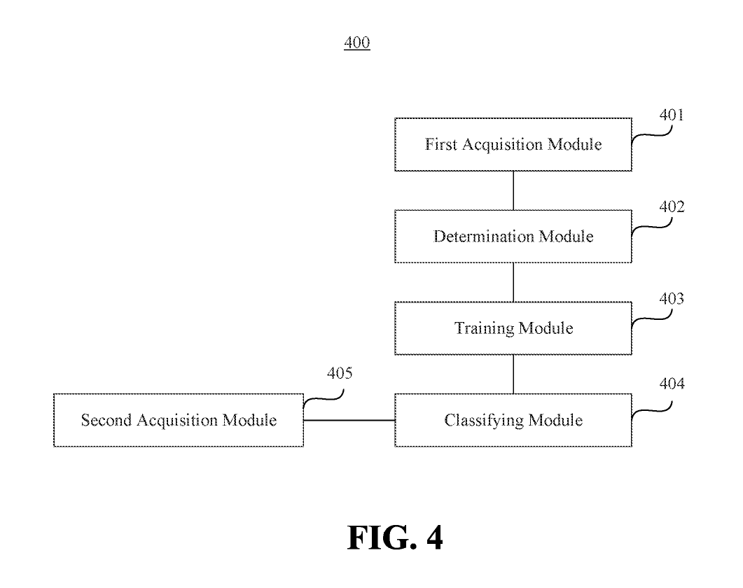

FIG. 4 is a block diagram of a device 400 for conducting classification model training according to an exemplary embodiment. Referring to FIG. 4, the device 400 may include a first acquisition module 401, a determination module 402, and a training module 403.

The first acquisition module 401 is configured to acquire sample feature vectors of a plurality of users according to at least one feature set for each of the users. The at least one feature set for a user is determined based on at least one sample message of the user.

The determination module 402 is configured to determine gender identifiers of the users according to the sample feature vectors.

The training module 403 is configured to conduct training based on the sample feature vectors and the gender identifiers corresponding to the sample feature vectors to construct a gender classification model.

In the illustrated embodiment, the classification device 400 obtains a gender classification model by acquiring sample feature vectors of a plurality of users according to at least one feature set for each of the users, determining gender identifiers of the users according to the sample feature vectors, and conducting training based on the sample feature vectors and the gender identifiers corresponding to the sample feature vectors. The gender classification model can be applied to gender classification so as to determine gender of a user according to the user's sample message such that information of the sample message can be increased to improve flexibility.

In an embodiment, the training module 403 is further configured to conduct the training based on the sample feature vectors and the gender identifiers corresponding to the sample feature vectors by using a decision tree algorithm to obtain the gender classification model.

In an embodiment, the training module 403 is further configured to perform:

(a) combining the sample feature vectors and the gender identifiers corresponding to the sample feature vectors to form a current set of feature data;

(b) acquiring, at a current level, gain values of feature dimensions of the current set of feature data, wherein a feature dimension corresponds to a feature value at a corresponding position within the sample feature vectors, and a gain value corresponding to the feature dimension represents an extent to which the feature dimension affects results of gender classification;

(c) determining a feature dimension within the current set of feature data that has the largest gain value as a test dimension, and constructing, at the current level, a node corresponding to the test dimension;

(d) dividing the current set of feature data into at least one subset of the feature data in accordance with a feature value corresponding to the test dimension in the current set of feature data, and deleting feature values corresponding to the test dimension from the at least one subset, to obtain at least one set of feature data;

(e) forwarding the at least one set of feature data to a level lower than the current level and constructing a branch node of the node at the current level according to the at least one set of feature data;

(f) repeating steps (b)-(e) until a current set of feature data contains one kind of gender identifier;

(g) constructing a node according to the gender identifier; and

(h) assembling the nodes constructed at the levels to form the gender classification model.

In an embodiment, the device 400 may further include a classifying module 404 configured to determine a gender identifier of a target user based on the gender classification model to classify the target user.

In an embodiment, the classifying module 404 is further configured to: acquire a target feature vector of the target user according to at least one feature set for the target user, wherein the at least one feature set for the target user is determined based on at least one target message of the target user; and determine the gender identifier of the target user according to the target feature vector and the gender classification model.

In an embodiment, the device 400 may further include a second acquisition module 405 configured to acquire the at least one target message of the target user in each preset period of time, and determining the at least one feature set for the target user from the at least one target message; or acquire the at least one target message of the target user upon detection that target messages of the target user have increased by a preset threshold number, and determining the at least one feature set for the target user from the at least one target message.

In an embodiment, the at least one feature set for the target user may include at least one of a salutation feature set, an operation feature set, or an application feature set.

In an embodiment, the salutation feature set may include a male salutation feature set and a female salutation feature set.

In an embodiment, the operation feature set may include at least one of the following parameters: a number of times of online shopping, a number of timing of participating in group-shopping, and an amount of consumption per month in a monthly bill.

In an embodiment, the application feature set may include one of the following parameters: a number of APP registration and gender-specific APP.

The specific manners for the various modules of the device 400 to perform their operations has been described in detail with respect to the method embodiments, and will not be repeated herein.

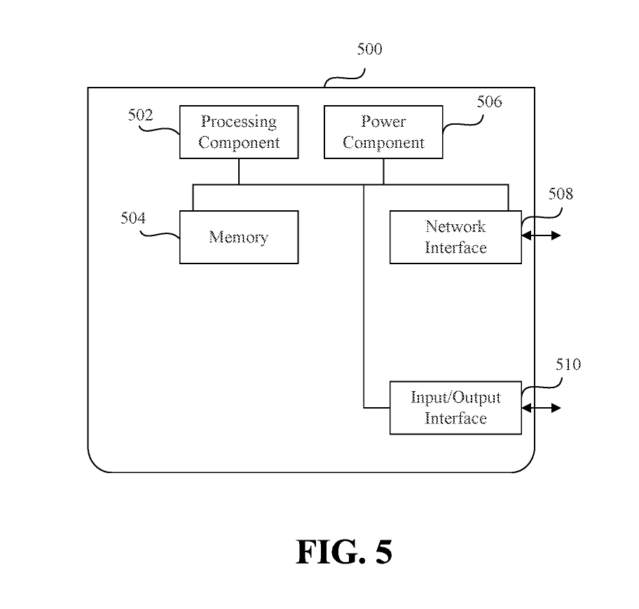

FIG. 5 is a block diagram of a device 500 for conducting classification model training according to yet another exemplary embodiment. The device 500 may be provided as a server, for example. As shown in FIG. 5, the device 500 may include a processing component 502, which in turn may include one or more processors. The device 500 may further include memory resources denoted by a memory 504, for storing instructions such as application programs executable by the processing component 502. The application programs stored in the memory 504 may include one or more modules, each of which corresponds to a set of instructions. Further, the processing component 502 is configured to execute the instructions to perform the methods for conducting classification model training as described above.

The device 500 may also include a power component 506 configured to perform power management of the device 500, a wired or wireless network interface 508 configured to connect the device 500 to a network, and an input/output (I/O) interface 510. The device can operate based on an operating systems stored in the memory 504, such as Windows Server™, Mac OS X™, Unix™, Linux ™ FreeBSD™, or the like.

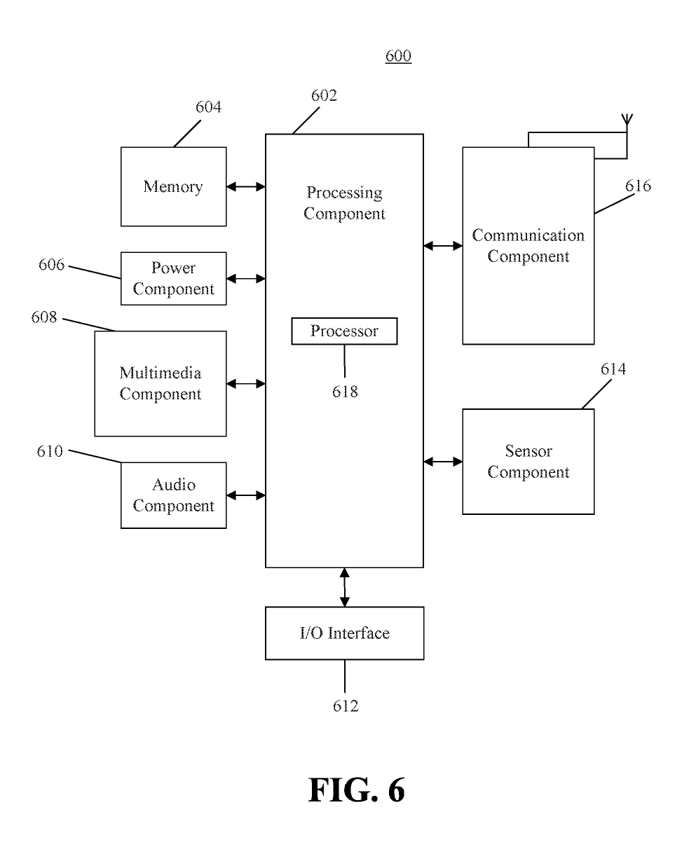

FIG. 6 is a block diagram of a device 600 for conducting classification model training according to yet another exemplary embodiment. The device 600 may be, for example, a mobile phone, a computer, a digital broadcast terminal, a messaging device, a gaming console, a tablet, a medical device, an exercise equipment, a personal digital assistant, and the like.

Referring to FIG. 6, the devicde 600 may include one or more of the following components: a processing component 602, a memory 604, a power component 606, a multimedia component 608, an audio component 610, an input/output (I/O) interface 612, a sensor component 614, and a communication component 616.

The processing component 602 typically controls overall operations of the device 600, such as the operations associated with display, telephone calls, data communications, camera operations, and recording operations. The processing component 602 may include one or more processors 618 to execute instructions to perform all or part of the steps in the above described methods. Moreover, the processing component 602 may include one or more modules which facilitate interaction between the processing component 602 and other components. For instance, the processing component 602 may include a multimedia module to facilitate interaction between the multimedia component 608 and the processing component 602.

The memory 604 is configured to store various types of data to support the operation of the device 600. Examples of such data may include instructions for any applications or methods operated on the device 600, contact data, phonebook data, messages, pictures, video, etc. The memory 604 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 606 provides power to various components of the device 600. The power component 606 may include a power management system, one or more power sources, and any other components associated with generation, management, and distribution of power for the device 600.

The multimedia component 608 include a screen providing an output interface between the device 600 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 608 includes a front camera and/or a rear camera. The front camera and the rear camera may receive an external multimedia datum while the device 600 is in an operation mode, such as a photographing mode or a video mode. Each of the front camera and the rear camera may be a fixed optical lens system or have optical focusing and zooming capability.

The audio component 610 is configured to output and/or input audio signals. For example, the audio component 610 includes a microphone configured to receive an external audio signal when the device 600 is in an operation mode, such as a call mode, a recording mode, and a voice recognition mode. The received audio signal may be further stored in the memory 604 or transmitted via the communication component 616. In some embodiments, the audio component 610 may further include a speaker to output audio signals.

The I/O interface 612 provides an interface between the processing component 602 and peripheral interface modules, the peripheral interface modules being, for example, a keyboard, a click wheel, buttons, and the like. The buttons may include, but are not limited to, a home button, a volume button, a starting button, and a locking button.

The sensor component 614 includes one or more sensors to provide status assessments of various aspects of the device 600. For instance, the sensor component 614 may detect an open/closed status of the device 600, relative positioning of components (e.g., the display and the keypad, of the device 600 ), a change in position of the device 600 or a component of the device 600, a presence or absence of user contact with the device 600, an orientation or an acceleration/deceleration of the device 600, and a change in temperature of the device 600. The sensor component 614 may include a proximity sensor configured to detect the presence of a nearby object without any physical contact. The sensor component 614 may also include a light sensor, such as a CMOS or CCD image sensor, for use in imaging applications. In some embodiments, the sensor component 614 may also include an accelerometer sensor, a gyroscope sensor, a magnetic sensor, a pressure sensor, or a temperature sensor.

The communication component 616 is configured to facilitate communication, wired or wirelessly, between the device 600 and other devices. The device 600 can access a wireless network based on a communication standard, such as WiFi, 2G or 3G or a combination thereof. In an exemplary embodiment, the communication component 616 receives a broadcast signal or broadcast associated information from an external broadcast management system via a broadcast channel. In an exemplary embodiment, the communication component 616 may further include a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 600 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory in the device 500 (FIG. 5) or 600 (FIG. 6). The instructions can be executed by the processing component of the device 500 or the device 600, for performing the above-described methods for conducting classification model training. For example, the non-transitory computer-readable storage medium may be a ROM, a RAM, a CD-ROM, a magnetic tape, a floppy disc, an optical data storage device, and the like.

Other embodiments of the invention will be apparent to those skilled in the art from consideration of the specification and practice of the disclosures herein. This application is intended to cover any variations, uses, or adaptations of the disclosure following the general principles thereof and including such departures from the present disclosure as come within known or customary practice in the art. It is intended that the specification and embodiments be considered as exemplary only, with a true scope and spirit of the invention being indicated by the following claims.

It will be appreciated that the present disclosure is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for conducting classification model training, comprising:
acquiring sample feature vectors of a plurality of users according to at least one feature set for each of the users, wherein the at least one feature set for a user is determined based on at least one sample message of the user;
determining gender identifiers of the users according to the sample feature vectors; and
conducting training based on the sample feature vectors and the gender identifiers corresponding to the sample feature vectors to construct a gender classification model.

2. The method of claim 1, wherein the training based on the sample feature vectors and the gender identifiers corresponding to the sample feature vectors is conducted using a decision tree algorithm to construct the gender classification model.

3. The method of claim 2, wherein conducting the training based on the sample feature vectors and the gender identifiers corresponding to the sample feature vectors by using a decision tree algorithm to construct the gender classification model comprises:
(a) combining the sample feature vectors and the gender identifiers corresponding to the sample feature vectors to form a current set of feature data;
(b) acquiring, at a current level, gain values of feature dimensions of the current set of feature data, wherein a feature dimension corresponds to a feature value at a corresponding position within the sample feature vectors, and a gain value corresponding to the feature dimension represents an extent to which the feature dimension affects results of gender classification;
(c) determining a feature dimension within the current set of feature data that has the largest gain value as a test dimension, and constructing, at the current level, a node corresponding to the test dimension;
(d) dividing the current set of feature data into at least one subset of the feature data in accordance with a feature value corresponding to the test dimension in the current set of feature data, and deleting feature values corresponding to the test dimension from the at least one subset, to obtain at least one set of feature data;
(e) forwarding the at least one set of feature data to a level lower than the current level and constructing a branch node of the node at the current level according to the at least one set of feature data;
(f) repeating (b)-(e) until a current set of feature data contains one kind of gender identifier;
(g) constructing a node according to the gender identifier; and
(h) assembling the nodes constructed at the levels to form the gender classification model.

4. The method of claim 1, further comprising:
determining a gender identifier of a target user based on the gender classification model to classify the target user.

5. The method of claim 4, wherein the determining a gender identifier of the target user based on the gender classification model comprises:
acquiring a target feature vector of the target user according to at least one feature set for the target user, wherein the at least one feature set for the target user is determined based on at least one target message of the target user; and
determining the gender identifier of the target user according to the target feature vector and the gender classification model.

6. The method of claim 5, further comprising performing at least one of:
acquiring at least one target message of the target user in each preset period of time, and determining the at least one feature set for the target user from the at least one target message; or
acquiring at least one target message of the target user upon detection that a number of target messages of the target user increases by a preset threshold number, and determining the at least one feature set for the target user from the at least one target message.

7. The method of claim 1, wherein the at least one feature set comprises at least one of a salutation feature set, an operation feature set, or an application feature set.

8. The method of claim 7, wherein the salutation feature set comprises a male salutation feature set and a female salutation feature set.

9. The method of claim 7, wherein the operation feature set comprises at least one of a number of times of online shopping, a number of times participating in group-shopping, or an amount of consumption per month.

10. The method of claim 7, wherein the application feature set comprises one of a number of application APP registration or gender-specific APP.

11. A device, comprising:
a processor;
a memory configured to store instructions executable by the processor, wherein the processor is configured to:
acquire sample feature vectors of a plurality of users according to at least one feature set for each of the users, wherein the at least one feature set for a user is determined based on at least one sample message of the user;
determine gender identifiers of the users according to the sample feature vectors; and
conduct training based on the sample feature vectors and the gender identifiers corresponding to the sample feature vectors to construct a gender classification model.

12. The device of claim 11, wherein the processor is further configured to conduct the training based on the sample feature vectors and the gender identifiers corresponding to the sample feature vectors by using a decision tree algorithm to construct the gender classification model.

13. The device of claim 12, wherein the processor is further configured to:
(a) combine the sample feature vectors and the gender identifiers corresponding to the sample feature vectors to form a current set of feature data;
(b) acquire, at a current level, gain values of feature dimensions of the current set of feature data, wherein a feature dimension corresponds to a feature value at a corresponding position within the sample feature vectors, and a gain value corresponding to the feature dimension represents an extent to which the feature dimension affects results of gender classification;
(c) determine a feature dimension within the current set of feature data that has the largest gain value as a test dimension, and construct, at the current level, a node corresponding to the test dimension;
(d) divide the current set of feature data into at least one subset of the feature data in accordance with a feature value corresponding to the test dimension in the current set of feature data, and delete feature values corresponding to the test dimension from the at least one subset, to obtain at least one set of feature data;
(e) forward the at least one set of feature data to a level lower than the current level and construct a branch node of the node at the current level according to the at least one set of feature data;
(f) repeat (b)-(e) until a current set of feature data contains one kind of gender identifier;
(g) construct a node according to the gender identifier; and
(h) assemble the nodes constructed at the levels to form the gender classification model.

14. The device of claim 11, wherein the processor is further configured to determine a gender identifier of a target user based on the gender classification model to classify the target user.

15. The device of claim 14, wherein the processor is further configured to:
acquire a target feature vector of the target user according to at least one feature set for the target user, wherein the at least one feature set for the target user is determined based on at least one target message of the target user; and
determine the gender identifier of the target user according to the target feature vector and the gender classification model.

16. The device of claim 15, wherein the processor is further configured to perform at least one of:
acquiring at least one target message of the target user in each preset period of time, and determining the at least one feature set for the target user from the at least one target message; or
acquiring at least one target message of the target user upon detection that target messages of the target user increases by a preset threshold number, and determining the at least one feature set for the target user from the at least one target message.

17. The device of claim 11, wherein the at least one feature set comprises at least one of a salutation feature set, an operation feature set, or an application feature set.

18. The device of claim 17, wherein the salutation feature set comprises a male salutation feature set and a female salutation feature set.

19. The device of claim 17, wherein the operation feature set comprises at least one of a number of times of online shopping, a number of times participating in group-shopping, or an amount of consumption per month.

20. The device of claim 17, wherein the application feature set comprises one of a number of application APP registration or gender-specific APP.

21. A non-transitory computer-readable storage medium storing instructions that, when executed by a processor of a device, cause the device to perform a method for conducting classification model training, the method comprising:
acquiring sample feature vectors of a plurality of users according to at least one feature set for each of the users, wherein the at least one feature set for a user is determined based on at least one sample message of the user;
determining gender identifiers of the users according to the sample feature vectors; and
conducting training based on the sample feature vectors and the gender identifiers corresponding to the sample feature vectors to construct a gender classification model.
